(19) United States
(12) Patent Application Publication
(10) Pub. No.: US 2018/0228690 A1
(43) Pub. Date: Aug. 16, 2018

(54) SEX TOY

(71) Applicant: Lorenzo HIRSCH, TRIESTE (IT)

(72) Inventor: Lorenzo HIRSCH, TRIESTE (IT)

(21) Appl. No.: 15/750,476

(22) PCT Filed: Jul. 29, 2016
(86) PCT No.: PCT/IT2016/000188

§ 371 Date: Feb. 5, 2018

(30) Foreign Application Priority Data
Aug. 5, 2015 (IT) 102015000042169

(51) Int. Cl. A61H 19/00

(52) U.S. Cl. CPC A61H 19/32; A61H 2201/0207; A61H 2201/1253; A61H 2201/0278; A61H 2201/1207; A61H 2201/0228

(57) ABSTRACT

Sex toy comprising a hollow container (1), a first inner element (2), a second inner element (3), some protrusions (4), a long pitch screw (5), means for moving the long pitch screw (5) and two lubricant systems with substances acting at body temperature; the container (1) being cylindrical in shape with an open end; the first inner element (2) being a flexible sheath; the second inner element (3) being located between the first inner element (2) and the walls of the container (1); the free extremities of the second inner element (3) touching and sliding on the first inner element (2) imitating the action of the mouth; the protrusions (4) extending inwards from the wall of the container (1); the means for moving the long pitch screw (5) allowing the movement of the first and second inner element (2, 3) in respect to the container (1).

### TECHNICAL FIELD

This invention relates to an improved sex toy of the kind known as male masturbators, able to reproduce specifically on the male sexual organ an effect similar to the fellatio.

### BACKGROUND ART

Adult sex toys of the kind of male masturbators have been known for a long time. Also known are sex toys able to recreate an effect similar to the fellatio, commonly known as “blow job simulators”. The fellatio reproduces the penetration movement with the difference that it also stimulates the male sexual organ thanks to the pressure of the lips on the penis. This effect is recreated by the elastic elements located on the open extremity of the male masturbators.

One of the most common types consists of a rigid cylindrical container in which the male sexual organ is inserted. Said rigid container is hollow and equipped with pneumatic systems changing the internal pressure and therefore increasing the pressure on the male organ and ensuring pleasure with a delicate aspiration. US2009/0099413 A1 describes a sex toy comprising a hollow container, at least one inner element, some protrusions on the inner element, a long pitch screw and means for moving said long pitch screw. Said container has an open end and a closed end including a threaded hole at its center. The pressure variation inside the container is obtained through a mechanism formed by a screw passing through the threaded hole of the closed end of the container and a cup. The screw rests against the cup. A more cost-effective method for applying radial pressure is to connect the screw to the closed end of the inner element. The operation is such that the movement of the screw applies a tension force along the longitudinal axis of the inner element.

In other cases, the pressure variation inside the container is created by an air bellow located at the base of the container or by a hollow sphere linked by a tube to the upper end of the container. An example of a container with this kind of pressure variation is described in US2006235266. Containers with this kind of pneumatic system are equipped with a manually activated valve that allows the air to come back to the container, reducing the internal pressure and allowing the removal of the penis.

The rigid container presents an inner element molded in such a way as to reproduce the female sexual organ. In US2009/0099413 A1 said inner element is a flexible synthetic or organic sheath including a body and a head; the body has a cylindrical shape and its open proximal end is surrounded by a semi-rigid flange element; the distal end of the body is a unit with the head; the head has a projection on distal end thereof; the head projection includes at least one seat which houses a restraining element placed at one end of the screw. The inner liner is constructed from suitable self-lubricating, easily cleanable materials appropriate for its application.

Some sex toys also present additional elements to increase the contact with the male organ. The same US2009/0099413 A1 describes protrusions being made of synthetic material and having a lenticular or spherical cap shape on the inner element. Other examples of sex toys with this kind of elements are described in GB 2271511, WO2010082316 and JP2008148774.

Some of these sex toys involve the use of lubricant creams to reduce the friction between the parts and to increase the user's pleasure thanks to their components.

### DISCLOSURE OF INVENTION

It is the object of the present invention to create a sex toy of the kind commonly known as “blow job simulator” able to recreate on the male sexual organ an effect similar to the fellatio and therefore acting not only at the base of the male organ but all along it.

This and other objects are obtained by the present sex toy, comprising of a hollow container, a first inner element, a second inner element, a long pitch screw, means for moving the long pitch screw and two lubricating systems.

The hollow container is preferably cylindrical with an open end.

On the internal walls of the hollow container there is at least one seat, opening towards the inner part of the container itself. Said at least one seat preferably continues along the whole internal perimeter of the container. The closed end of the container presents a treaded hole.

The wall of the container presents protrusions towards its inner part. Said protrusions are made of synthetic material and have preferably a lenticular shape or a spherical cap shape. Said protrusions are whether one-piece on the inner walls of the container or autonomous and linked to the walls before using.

The first and the second inner element are coaxial with the container. The first inner element is made of a flexible synthetic or organic sheath including a body and a head. The body has a cylindrical shape with an open first end surrounded by a semi-rigid flange element protruding outwards. The second end of the body is a unit with the head. The head has a wider diameter than the body and presents a projection on its distal end. Said head projection could be thicker than the rest of the head and of the body. The head projection is crossed by a channel. In the head projection there is at least one seat holding the restraining element of the long pitch screw. The first inner element can be interchangeable.

The first lubricating system consists of at least one cavity and some micro-holes. Said cavity is located inside the walls of the body of the first inner element. Each cavity is linked to the internal part of the body by means of micro-holes opening on the wall separating the cavity from the internal part of the body. Inside each cavity there are single or bicomponent lubricant substances. In the first case, the mix due to the compression generates heat. In the second case, the lubricant substances are warmed by electrical resistances inserted in the body of the first inner element, alimented through power supply or electric accumulators. The second inner element consists of a hollow cup made of flexible and semi-rigid organic or synthetic material in the shape of a truncated ellipsoid of rotation. The second inner element is located between the first inner element and the walls of the container. The second inner element can be a one-piece body or can be formed by at least two foils linked one another at a distal extremity. Said foils might be of different width, length and degree of flexibility. Each foil might present a fringed free extremity. The second inner element has a central threaded hole in the distal end.

The hollow long pitch screw presents a restraining element at the extremity internal to the container. The screw goes through the threaded hole on the closed extremity of the container, the threaded hole located on the distal end of the second inner element, the restraining element located at its extremity internal to the container and enters in the seat of the head projection of the first inner element temporarily holding the first inner element to the screw. A channel with a longitudinal axis coaxial to the longitudinal axis of the screw goes through the screw itself.

The long pitch screw can be activated manually or electrically, allowing the movement of the inner elements with respect to the container. In the first case, the means for moving consist of a spring and a knob. The knob is formed by a circular plate presenting, on the wall closest to the closed extremity of the container, a first seat and a tube and a second seat on the opposite wall. The first seat holds a ball bearing in which the extremity of the screw located on the outside of the container is inserted. The ball bearing is rotationally linked to the knob. The temporary fixing between the screw and the knob is obtained through an o-ring located on the extremity of the tube. The tube presents a channel linked to the channel of the screw. Between the knob and the closed extremity of the container is inserted a spring enclosing the screw.

The second seat holds the edges of a laminar lid, shaped as a concave lens.

A second lubricating system uses the knob and the channel of the screw. Between the internal surface of the laminar lid and the wall of the knob there is a compartment holding a container in which a first lubricating substance is being housed. A second lubricating substance is located inside the channel of the lid.

The mix of the two lubricating substances is obtained by evagination, piercing the container housing the first substance with a needle fixed on the wall of the convex part of the laminar lid.

To ensure the use of both lubricating systems, the first inner element and the knob are disposable.

When electrically activated, the long pitch screw is connected to an electrical engine equipped with electronic control counting at least one programmable board with microcontroller, alimented through power supply or electric accumulators. The electrical engine is activated by a remote control equipped with an intensity regulation device. To allow its use, it is necessary to change the lubricating system on the first inner element before each use.

### BRIEF DESCRIPTION OF DRAWINGS

The invention is presented below in an exemplary embodiment and in connection with the attached drawings on which:

FIG. 1 shows a longitudinal section of the sex toy;

FIG. 2 shows a longitudinal section of the container of the sex toy;

FIG. 3 shows a longitudinal section of the first inner element of the sex toy;

FIG. 4 shows a longitudinal section of the second inner element of the sex toy and of the means for moving the long pitch screw;

FIGS. 5 and 6 show two longitudinal sections of a knob of the sex toy, respectively in an open and closed position.

### BEST MODE FOR CARRYING OUT THE INVENTION

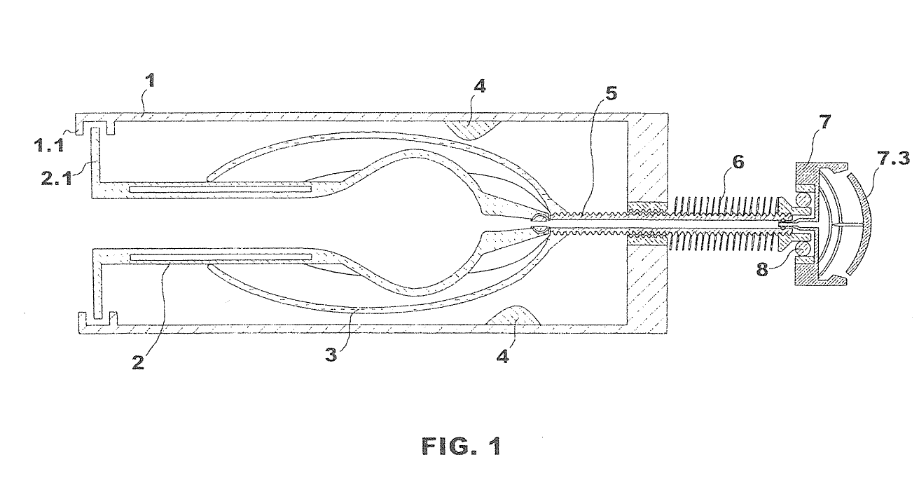

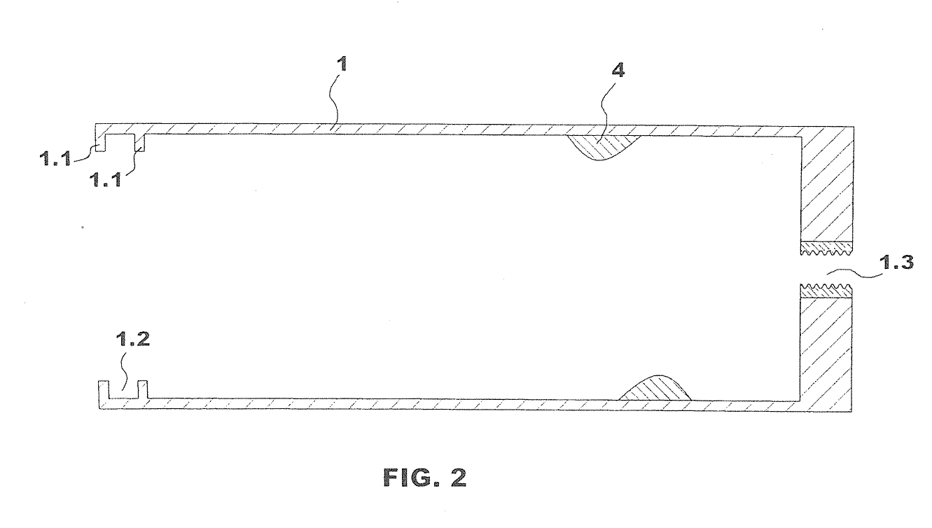

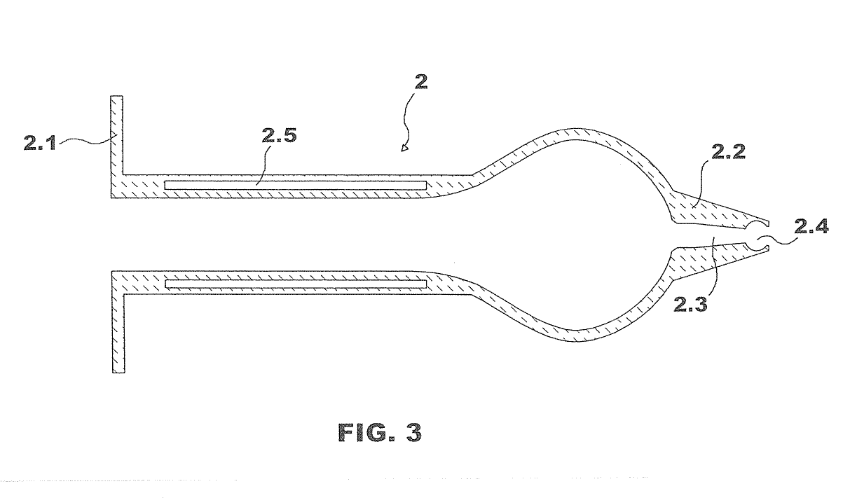

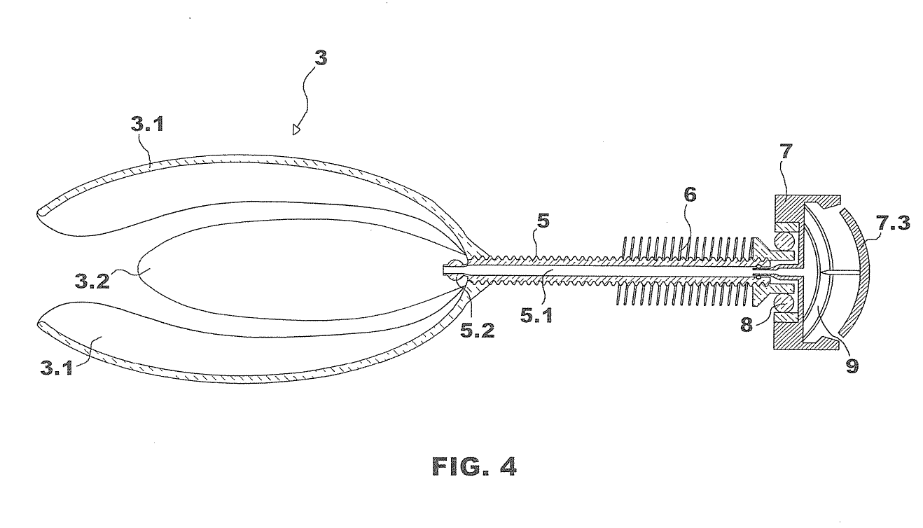

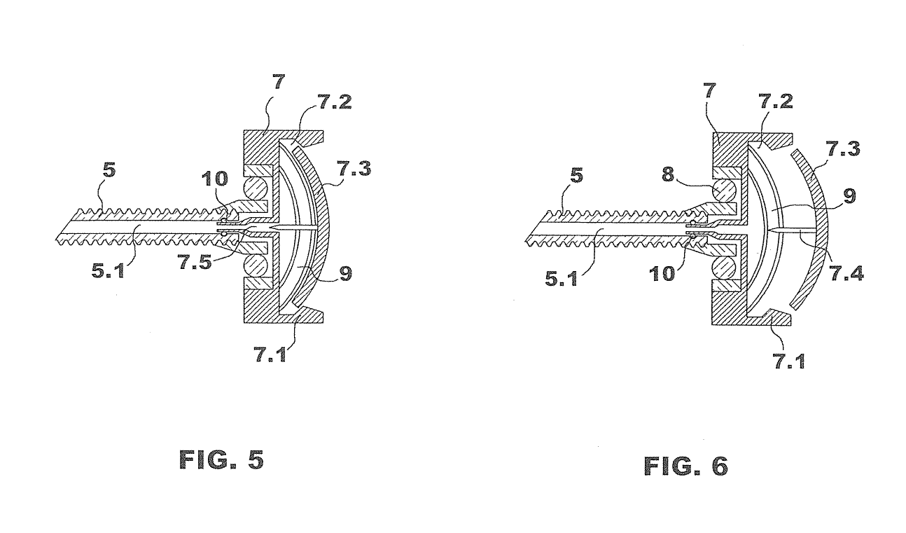

With reference to FIGS. 1-6, there is shown a preferred embodiment of the sex toy. It is composed by a hollow container 1, a first inner element 2, a second inner element 3 and means for movement of the two inner elements 2, 3.

The hollow container 1 is cylindrical with an open end. Next to its open extremity, on the walls of the container 1, there are two ring-shaped, one-piece detached flanges 1.1. They encircle a ring-shaped seat 1.2 open towards the inner part of the container 1. The closed end of the container 1 includes a threaded hole 1.3 at its center.

Adherent to the inner walls of the container 1, the protrusions 4 are made of synthetic material with a spherical cup shape and protrude toward inside thereof. The protrusions 4 are equipped with adhesive substances on their base.

The first inner element 2 and the second inner element 3 are coaxial to the container 1. The first inner element consists of a flexible synthetic sheath including a body and a head. The body is cylindrical with a first open end surrounded by a semi-rigid flange element 2.1 protruding outwards. The second end of the body is a unit with the head. The head has a wider diameter than the body and presents a projection 2.2 on its distal end. Said head projection 2.2 is thicker than the rest of the head. The head projection is crossed by a channel 2.3, enlarging at its distal to form a spherical seat 2.4.

The sex toy has a first system of lubrication including at least one cavity 2.5 and some micro-holes. In detail, within the walls of the body of the first inner element 2 there is a ring-shaped cavity 2.5. Said cavity 2.5 is linked to the internal part of the body by means of micro-holes opening on the wall separating the cavity 2.5 from the internal part of the body. Bicomponent lubricant substances are housed inside the cavity 2.5.

The second inner element 3 is inserted between the first inner element 2 and the walls of the container 1. Said second inner element 3 is a hollow cup in the shape of a truncated ellipsoid of rotation formed by flexible semi-rigid synthetic foils 3.1, 3.2 connected at one end. The first series of foils 3.1 is longer than the second series of foils 3.2. At the distal end of the second inner element 3, where said foils are connected, there is a central threaded hole.

The means for moving the two internal elements 2, 3 include a long pitch screw 5 a spring 6 and a knob 7. A channel 5.1 passes through said screw 5; the longitudinal axis of said channel 5.1 is coaxial to the longitudinal axis of the screw 5. The long pitch screw 5 goes through the threaded hole 1.3 on the closed end of the container 1 and the threaded hole on the second inner element 3. On the extremity of the screw 5 located inside the container 1 there is a one-piece sphere 5.2, also crossed by the channel 5.1. The sphere 5.2 enters the spherical seat 2.4 on the head projection of the first inner element 2, temporarily holding it to the hollow screw 5.

The extremity of the screw 5 located outside the container 1 is inserted in a ball bearing 8 rotationally linked to a first wall of the knob 7, next to the closed extremity of the container 1. The spring 6 encloses the screw 5 and is located between the knob 7 and the closed extremity of the container 1.

The knob 7 is formed by a circular plate with a first seat in a wall close to the closed extremity of the container 1 and a tube and a second seat on the opposite wall. The first seat holds said ball bearing 8. The second seat is delimited by a circular crown 7.1. In the circular crown 7.1 there is a ring-shaped opening 7.2 facing inwards. The edges of a laminar lid 7.3, molded as a convex lens, enter inside the opening 7.2 of the knob 7. Said laminar lid is equipped with a needle 7.4 linked on the convex part, its central longitudinal axis being coincident with the longitudinal axis of the lid 7.3.

A second lubricating system uses the knob 7 and the channel 5.1 of the screw 5. When the lid 7.3 is blocked inside the opening 7.2, there is a compartment between the inner surface of the laminar lid 7.3 and the distal wall of the knob 7. Inside said compartment there is a container 9, in which is housed a first lubricant substance. A central channel 7.5 orthogonal to the circular plate goes through the circular plate of the knob 7 itself and the tube. In said channel 7.5 is housed a second lubricant substance; said channel 7.5 is closed on one side by the container 9 and on the other side by a plastic removable tab closing the distal extremity of the tube. The temporary fixing between the screw 5 and the knob 7 is obtained through an o-ring 10 located at the extremity of the tube. Channel 7.5 of the knob 7 is connected with channel 5.1 of the screw 5 and channel 2.3 of the first inner element 2.

While operating, the second inner element 3 is already inserted in the container 1 and fixed to the screw 5. The first inner element 2 is therefore completely inserted in the hollow container 1. The ring-shaped flange 2.1 of the first inner element 2 is inserted in the ring-shaped seat 1.2 located close to the open extremity of the container 1, preventing the involuntary detachment of the first inner element 2 from the container 1. The sphere 5.2, located on the extremity of the screw 5 inside the container 1, enters into the spherical seat 2.4 of the projection 2.2 of the head of the first inner element 2, temporarily blocking the first inner element 2 to the screw 5. The first inner element 2 fits perfectly to the shape and size of the penis thanks to its remarkable elasticity.

The plastic tab closing the channel 7.5 is removed from the knob 7 and therefore the knob 7 is temporarily fixed to the screw 5 through the o-ring 10.

Once thus assembled, the sex toy can be used.

Pulling the knob 7 towards the container 1 activates the rotation of the screw 5 and causes the longitudinal advance of the first inner element 2 and of the second inner element 3 with respect to the container 1. The free extremities of the foils 3.1, 3.2 of the second inner element 3 touch and slide on the first inner element 2. As the foils 3.1, 3.2 of the second inner element 3 are of a semi-rigid material, they reproduce the action of the mouth during the fellatio. Foils 3.1, 3.2 collide with the protrusions 4 on the inner walls of the container 1, augmenting the sensation of pressure on the penis. Releasing the knob 7, the spring 6 separates again the knob 7 from the container 1, causing the counter-rotation of the screw 5 and the retreating of the second inner element 3 from the first inner element 2. The lubricating substances inside the ring-shaped cavity 2.5 of the body of the first inner element 2 go through the micro-holes inside the first inner element 2, preventing irritations and pain, as the penis is not in contact with the lubricants naturally produced by the vagina. The compression exerted on the body of the first inner element 2 causes the mixing of the two lubricating elements. Said mix produces heat reaching almost body-temperature.

Bicomponent lubricants in the knob 7 behave in the same way. Pulling the lid 7.3 towards the knob 7 to allow its edges to enter the opening 7.2, its needle 7.4 pierces the container 9 and pulls the first lubricant to the second lubricant inside the channel 7.5. The two substances mix and generate heat. The activation of the screw 5 causes, thanks to a pneumatic action, the advancing of the self-heating bicomponent lubricant inside the channel 5.1 of the screw 5 and the channel 2.3 of the first inner element 2, up to the first inner element 2 itself.

To ensure the use of both lubricating systems, both the first inner element 2 and the knob 7 are disposable.

It is to be understood that many modifications and variations may be devised given the above description of the principles of the invention. It is intended that all such modifications and variations be considered as within the spirit and scope of this invention, as defined in the following claims.

1- Sex toy, comprising a hollow container (1), a first inner element (2), a second inner element (3), some protrusions (4), a long pitch screw (5) and means for moving the long pitch screw (5) in which said hollow container (1) being cylindrical in shape with an open end; the closed end of the container (1) including a threaded hole (1.3) at the center thereof; said protrusions (4) being made of synthetic material and having a lenticular or spherical cap shape; said first inner element (2) being a flexible synthetic or organic sheath including a body and a head; the body having a cylindrical shape and an its first end being open and surrounded by a semi-rigid flange element (2.1) protruding toward outside thereof; the second end of the body being as a unit with the head; the head having a projection (2.2) on distal end thereof; the head projection (2.2) including at least one seat (2.4) which houses a restraining element placed at the end placed inside the container (1) of said screw (5); said screw (5) passing through the threaded hole (1.3) of the closed end of the container (1) and the restraining element of its end placed inside the container (1) being housed in the seat (2.4) of the head projection (2.2) of the first internal member (2) temporarily fixing the first inner element (2) to screw (5);
characterized for further comprising:
on the inner walls of the hollow container (1) lies at least one seat (1.2) which is open towards the inside of the container (1);
the first inner element (2) and the second inner element (3) being coaxial to the container (1);
the head projection (2.2) of the first inner element (2) being crossed by a channel (2.3);
a first lubricating system with lubricating substances acting at body temperature including at least one cavity (2.5) and micro-holes; the walls of the body of the first inner element (2) including said at least one cavity (2.5); each cavity (2.5) being connected with the inside of said body through micro-holes opened in the wall delimiting each cavity (2.5) toward the inside of the body; within each cavity (2.5) lubricating substances being housed which generate heat up to a temperature similar to the body temperature;
said second inner element (3) being inserted between the first inner element (2) and the walls of the container (1); said second inner element (3) being a flexible semi-rigid organic or synthetic hollow cup of a truncated spherical or truncated ellipsoid of rotation shape; said second inner element (3) including at least two foils (3.1, 3.2) connected together at its distal end; the distal end of the second inner element (3) including a central threaded hole;
said screw (5) further passing through the threaded hole in the distal end of the second inner element (3); the longitudinal axis of the channel (5.1) being coaxial to longitudinal axis of the screw (5);
said means for moving the long pitch screw (5) being manually or electrically activated to allow the movement of the inner elements (2, 3) with respect to the container (1).

2- Sex toy, according to claim 1, characterized by the fact that said means for moving the long pitch screw (5) including a spring (6) and a knob (7); the knob (7) being formed by a circular plate having on the wall closest to the closed extremity of the container (1) a first seat and a tube and a second open seat on the opposite wall; said first seat holds a ball bearing (8); the second seat holds the edges of a laminar lid (7.3), shaped as a concave lens; said laminar lid (7.3) is equipped with a needle (7.4) fixed on the convex part, its central longitudinal axis being coincident with the longitudinal axis of the lid (7.3) and orthogonal to its walls; between the inner surface of the laminar lid (7.3) and the wall of the knob (7) there is a compartment; a central channel (7.5) orthogonal to the circular plate crosses the circular plate of the knob (7) itself and the tube; the channel (7.5) of the knob (7) communicates with the channel (5.1) of the screw (5) and the channel (2.3) of the first inner element (2); said spring (6) encircles the screw (5) and is located between the knob (7) and the closed extremity of the container (1).

3- Sex toy, according to claim 2, characterized by the fact that the extremity of the screw (5) located outside the container (1) is inserted in said ball bearing (8) rotationally linked to the knob (7); the temporary fixing between the screw (5) and the knob (7) is obtained by means of an o-ring (10) located at the extremity of the tube.

4- Sex toy, according to claim 2, characterized by the fact that it includes a second lubricating system including the knob (7) and the channel (5.1) of the screw (5); the compartment between the inner part of the laminar lid (7.3) and the wall of the knob (7) houses a container (9), filled with a first lubricant substance; a second lubricant substance is housed inside said channel (7.5) of the knob (7), closed on one part by the container (9) and on the distal end of the tube by a removable plastic tab; the two lubricant substances mix by pulling the lid (7.3) against the knob (7); said needle (7.4) pierces the container (9) and pulls the first lubricant substance towards the second lubricant substance housed inside the channel (7.5); the mix of the two lubricant substances generates heat almost reaching body-temperature.

5- Sex toy, according to claim 1, characterized by the fact that said means for moving the long pitch screw (5) include an electrical engine equipped with electronic control with at least one programmable board with microcontroller, supplied through power supply or electric accumulators; said electrical engine is activated by a remote control equipped with an intensity regulation device.

6- Sex toy, according to claim 1, characterized by the fact that said protrusions (4) are one-piece with the internal walls of the container (1).

7- Sex toy, according to claim 1, characterized by the fact that said protrusions (4) are glued to the inner walls of the container (1).

8- Sex toy, according to claim 1, characterized by the fact that said head projection (2.2) of the first inner element (2) is thicker than the rest of the head and the body.

9- Sex toy, according to claim 1, characterized by the fact that said lubricant substances housed inside said at least one cavity (2.5) of the body of the first inner element (2) are bicomponent and their mix, caused by manual compression, generates heat reaching almost body-temperature.

10- Sex toy, according to claim 1, characterized by the fact that that said lubricant substances housed inside said at least one cavity (2.5) of the body of the first inner element (2) are of single component and warmed by electrical resistances inserted in the body of the first inner element (2), supplied through power supply or electric accumulators.

11- Sex toy, according to claim 1, characterized by the fact that said second inner element (3) is of one-piece.

12- Sex toy, according to claim 1, characterized by the fact that said foils (3.1, 3.2) of the second inner element (3) have different width, length and degree of flexibility.

13- Sex toy, according to claim 1, characterized by the fact that the first inner element (2) is disposable.

14- Sex toy, according to claim 3, characterized by the fact that the knob (7) is disposable.
